(19) United States
(12) Patent Application Publication
(10) Pub. No.: US 2013/0196744 A1
(43) Pub. Date: Aug. 1, 2013

(54) ADAPTER FOR LOYALTY PROGRAM POINTS

(71) Applicants: Edward Q. Earley, Chicago, IL (US); Jeremy M. Hornik, Chicago, IL (US); Joel R. Jaffe, Glenview, IL (US); Matthew J. Ward, Northbrook, IL (US); John R. Werneke, Naperville, IL (US)

(72) Inventors: Edward Q. Earley, Chicago, IL (US); Jeremy M. Hornik, Chicago, IL (US); Joel R. Jaffe, Glenview, IL (US); Matthew J. Ward, Northbrook, IL (US); John R. Werneke, Naperville, IL (US)

(73) Assignee: WMS Gaming, Inc., Waukegan, IL (US)

(21) Appl. No.: 13/566,018

(22) Filed: Aug. 3, 2012

Related U.S. Application Data
(60) Provisional application No. 61/514,698, filed on Aug. 3, 2011.

(51) Int. Cl. G07F 17/32

(52) U.S. Cl. CPC G07F 17/3255
USPC 463/25

(57) ABSTRACT

An adapter for wagering game systems designed to communicate using a first protocol is provided that communicates with systems designed to communicate using a second protocol different from the first protocol. The adapter may provide a translation service that translates from the first protocol to the second protocol and vice-versa. Additionally, the adapter may provide a transaction clearing house service. The translation and transaction clearing house services provided by the adapter can be used to access disparate systems using disparate protocols. For example, a wagering game system that is designed to communicate with other wagering game systems using a first protocol can use the adapter to access loyalty points systems and other systems that are designed to use a second communications protocol.

### RELATED APPLICATIONS

This application claims the priority benefit of U.S. Provisional Application Ser. No. 61/514,698 filed Aug. 3, 2011

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, WMS Gaming, Inc.

### FIELD

Embodiments of the inventive subject matter relate generally to wagering game systems, and more particularly to wagering game systems including adapters for communicating messages to and from loyalty systems.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games, gaming enhancements and player services that will attract frequent play.

New games, gaming enhancements or player services may be implemented using servers and systems that are located either within a gaming establishment or external to a gaming establishment. Further, different manufacturers of gaming systems may employ proprietary systems to provide games, gaming enhancements or player services. Such proprietary systems may use proprietary communications protocols and message formats that are different from one another.

### BRIEF DESCRIPTION OF THE FIGURES

Embodiments of the invention are illustrated in the Figures of the accompanying drawings in which:

FIG. 1 is a block diagram depicting components of a wagering game system.

FIG. 2 is a block diagram depicting components of a wagering game system according to alternative embodiments.

FIGS. 3A and 3B are block diagrams depicting interfacing adapters to components of a wagering game system.

FIG. 4 illustrates a wagering game system in which an adapter communicates with a mobile device to support adaptive gaming functions.

FIG. 5 depicts components of a wagering game system in which the adaptive gaming server is distributed across a casino adaptive gaming server and a host adaptive gaming server.

FIG. 6 depicts components of a wagering game system in which a host adaptive gaming server uses an adapter to communicate with third party systems.

FIG. 7 is a flowchart depicting a method for providing offers to wagering game players in response to real time events occurring on a wagering game machine.

FIG. 8 is a flowchart illustrating a method for real time monitoring of events on a wagering game machine and notifying a third party system of when desired events occur.

FIG. 9 is a block diagram illustrating a wagering game machine architecture.

FIG. 10 is a block diagram illustrating a wagering game network.

FIG. 11 is a perspective view of a wagering game machine.

### DESCRIPTION OF THE EMBODIMENTS

This description of the embodiments is divided into five sections. The first section provides an introduction to embodiments of the invention, while the second section describes example wagering game system architectures. The third section describes example operations performed by some embodiments and the fourth section describes example wagering game machines in more detail. The fifth section presents some general comments.

### Introduction

This section provides an introduction to some embodiments of the invention. In general, the various embodiments comprise wagering game systems that include an adapter unit that allows wagering game systems designed to communicate using a first protocol to communicate with wagering game systems designed to communicate using a second protocol different from the first protocol. In some embodiments, the adapter unit provides a translation service that translates from the first protocol to the second protocol and vice-versa. In other embodiments, the adapter unit provides a transaction clearing house service. The translation and transaction clearing house services provided by the adapter units can be used to access disparate systems using disparate protocols. For example, a wagering game system that is designed to communicate with wagering game systems using a first protocol can use the adapter units to access loyalty points systems and other systems that are designed to use a second communications protocol.

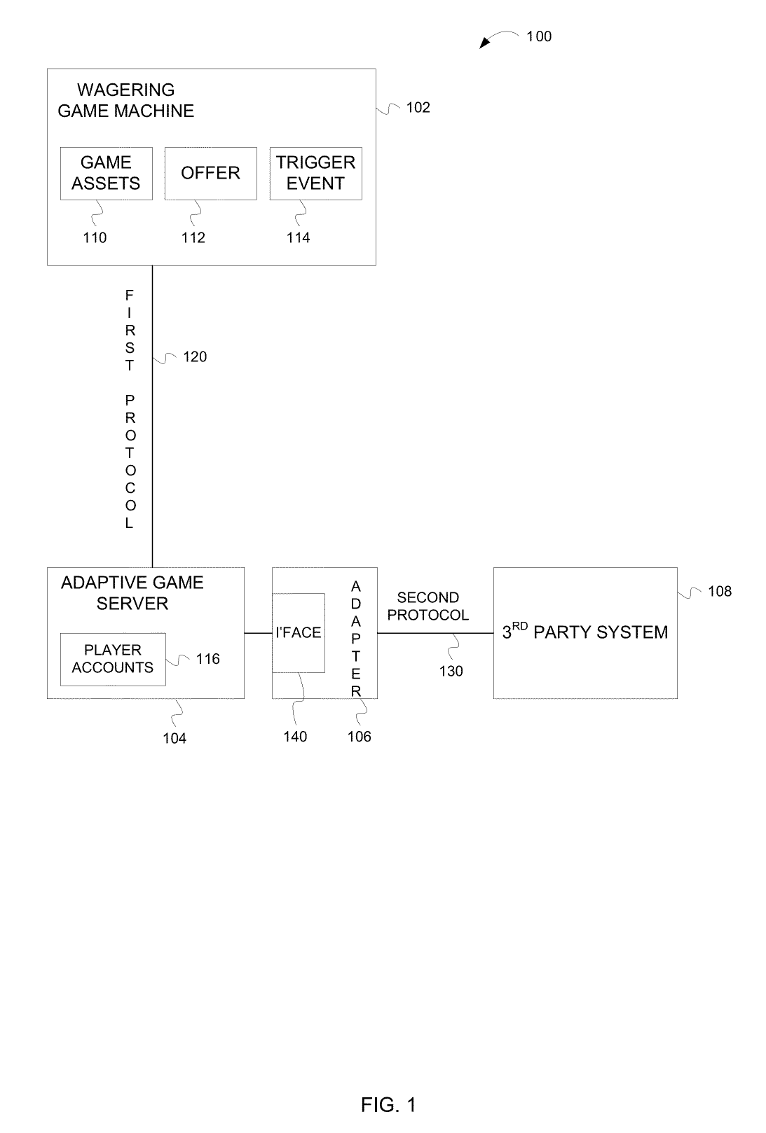

FIG. 1 is a block diagram depicting components of a wagering game system 100 according to embodiments. Wagering game system 100 may include one or more wagering game machines 102, an adaptive game server 104 and a third party system 108. A wagering game machine 102 can be an electromechanical wagering game machine configured to play mechanical slots, or it can be an electronic wagering game machine configured to play video casino games, such as blackjack, slots, keno, poker, blackjack, roulette, etc. Wagering game machine 102 may maintain game assets 110 for wagering games playable on wagering game machine 102.

Wagering game machine 102 may maintain various types of game assets 110. For example, game assets 110 may include bonus games available on the wagering game machine. Further, game asserts may include characters and accessory objects (jewelry, tools etc.) that appear during a wagering game or bonus game. Additionally, game assets 110 may include various styles of clothing or body characteristics (hair color, eye color, skin color etc.) for the characters appearing in a wagering game or bonus game presented on wagering game machine 102. Further, game assets may include features of the gaming symbols used during a wagering game or bonus game. For example, game asserts 110 may include various styles of card backs, reel symbols, wild symbols, or other game tokens.

Wagering game machine 102 may receive and maintain and offer 112 related to gaming assets 110. Typically the offer is directed to a player that can be identified via a player tracking card or account login. As an example, a player may be offered the opportunity to unlock a new bonus round in exchange for loyalty points in the player's casino loyalty system account.

An offer 112 may be associated with a trigger event 114. A trigger event is an event that must occur before the offer is presented to the player. As an example, a trigger event may occur when a player achieves a certain level in a wagering game or bonus game (e.g., a rank, miles travelled in a virtual world, trophy, badge etc.) The player may be offered the opportunity to be assigned a next higher level in exchange for loyalty points in the player's casino loyalty system account. Thus the player has the opportunity to advance through a bonus game sooner than would be the case had the player not been presented the offer.

Further details on offers and trigger events in various embodiments will be provided below.

Adaptive game server 104 is a server that is communicably coupled to a wagering game machine 102 and is operable to change (i.e., adapt) the appearance or operation of a wagering game machine 102 in accordance with the personal preferences, game achievements, or previously saved game state of a user of the wagering game machine. Adaptive game server 104 maintains player accounts 116. An account associates the personal preferences, game achievements or game state for a particular player with an identifier for the player. Player accounts 116 may be persistently stored on a database or other persistent data store accessible to adaptive game server 104. The personal preferences, game achievements or game state may be linked to a player's account, such as an account on a player tracking system or player loyalty system. When a user logs in to a wagering game machine, for example, by inserting a player tracking card into a card reader on the wagering game machine, the adaptive game server retrieves any preferences, game achievements, or game states applicable for the wagering game and communicates with the wagering game machine to adjust the operation of the wagering game machine according to the preferences, game achievements, or game state. In some embodiments, various elements from game assets 110 may be selected to adapt the wagering game machine to the preferences, game achievements, or game state for the user.

Although shown as one unit in FIG. 1, functionality provided by adaptive game server 104 may be distributed across multiple servers or machines. Additionally, game assets may be saved in a database or server and downloaded to wagering game machine 102 as needed.

Adaptive game server 104 and wagering game machine 102 communicate with one another using a first communication protocol 120. First communication protocol may be a protocol that is proprietary to the manufacturer of wagering game machine 102 and adaptive game server 104, or it may be a standardized protocol such as the G2S (Game To System) protocol developed by the Gaming Standards Association.

Wagering game system 100 includes a third party system 108. Third party system 108 is a system that is provided by a manufacturer or vendor that is different from the manufacturer or vendor of wagering game machine 102 and adaptive game server 104. Third party system may be a loyalty system such as a casino loyalty system that awards player with loyalty points in exchange for wagering activity of the player. Typically the loyalty points may be redeemed for services, merchandise, or gaming credits at a casino.

Third party system 108 communicates using a second protocol 130 that is different from first protocol 120. As with first protocol 120, second protocol 130 may be a protocol that is proprietary to the manufacturer of third party system 108, or it may be a protocol based on a standard communications protocol.

Adapter 106 includes various interfaces that adapt an application or service that communicates using one protocol for use by an application or service that communicates using a different protocol. In some embodiments, adapter 106 includes an interface 140 that provides a standardized API (Application Programming Interface) for adapter 106 to use in communicating with various third party systems. Interface 140 thus provides a consistent API that remains consistent regardless of the communications protocols used by the third party system. As an example, interface 140 may provide a standardized interface for communicating with a casino loyalty system that uses a communications protocol that is not supported by adaptive game server 104. The API may provide interface methods for retrieving available loyalty point amounts for an account, deducting loyalty points from an account, or adding loyalty points to an account. In response to calls to interface 140, adapter 106 converts or adapts the methods and data provided through interface 140 to methods and data that can be invoked or sent via second communications protocol 130.

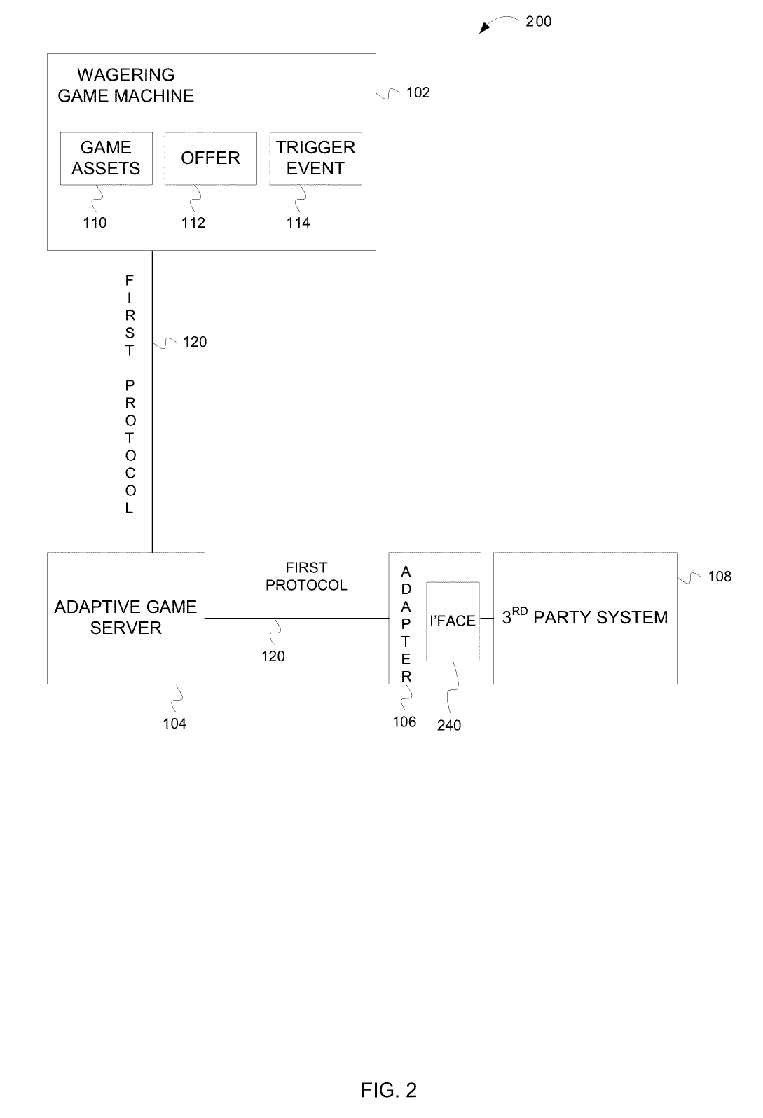

FIG. 2 is a block diagram depicting components of a wagering game system 200 according to alternative embodiments. Like system 100, wagering game system 200 may include one or more wagering game machines 102, an adaptive game server 104 and a third party system 108. In the example shown in FIG. 2, adapter 106 exposes an interface 240 to third party system 108. In the embodiments represented by FIG. 2, interface 240 provides an API to third party system 108 such that third party system 108 can use the API to initiate requests and respond to requests initiated by adaptive game server 104. In such embodiments, adapter 106 translates the methods and data submitted through interface 240 into methods and data that comply with first protocol 120.

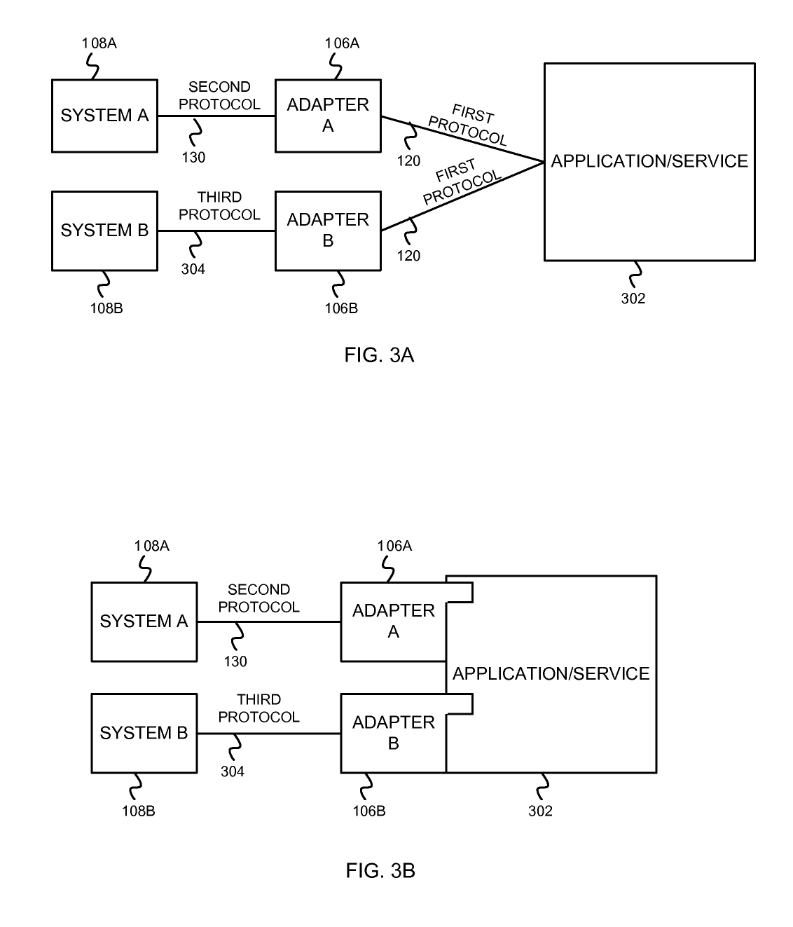

FIGS. 3A and 3B are block diagrams depicting interfacing adapters to components of a wagering game system according to embodiments, and further illustrate that multiple adapters may be coupled to applications and services in a wagering game system. The use of adapter 106 allows other third party systems employing various and possibly incompatible communications protocols to be integrated into a wagering game system without requiring changes to applications or services 302 such as those provided by adaptive game server 106. When a new third party system 108B is to be integrated with a system that uses a third communications protocol 320, a previously existing adapter can be modified to communicate using the communications protocols of the new third party system. Alternatively a new adapter 106B can be developed that provides the same interface 140 along with conversion or translation functionality to communicate using the third communications protocol 320 of the new third party system 108B.

FIG. 3A illustrates an environment in which adapters 106A and 106B are coupled to an application or service 302 using a service architecture. In some embodiments, adapters 106A and 106B are services that adapt communications received in a first protocol 120 to communications in a protocol suitable for target system 106A or 106B. Applications desiring to use the services of an adapter 106A or 106B communicate with an adapter by sending messages to the adapter.

FIG. 3B illustrates an environment in which adapters 106A and 106B are coupled to an application or service 302 using a plug-in architecture. In some embodiments, adapters 106A and 106B are designed as plug-ins. Plug-ins may also be referred to as “add-ons” or “snap-ins.” In general, plug-in architectures provide the ability to dynamically (i.e., at run-time) add capability to an application or service. Various types of plug-in architectures can be used in various embodiments. In some embodiments libraries such as DLL (Dynamically Linked Libraries) or shared object libraries (“.so” libraries) can be used to provide plug-ins.

Although FIGS. 1-3 describe some embodiments, the following sections describe many other features and embodiments.

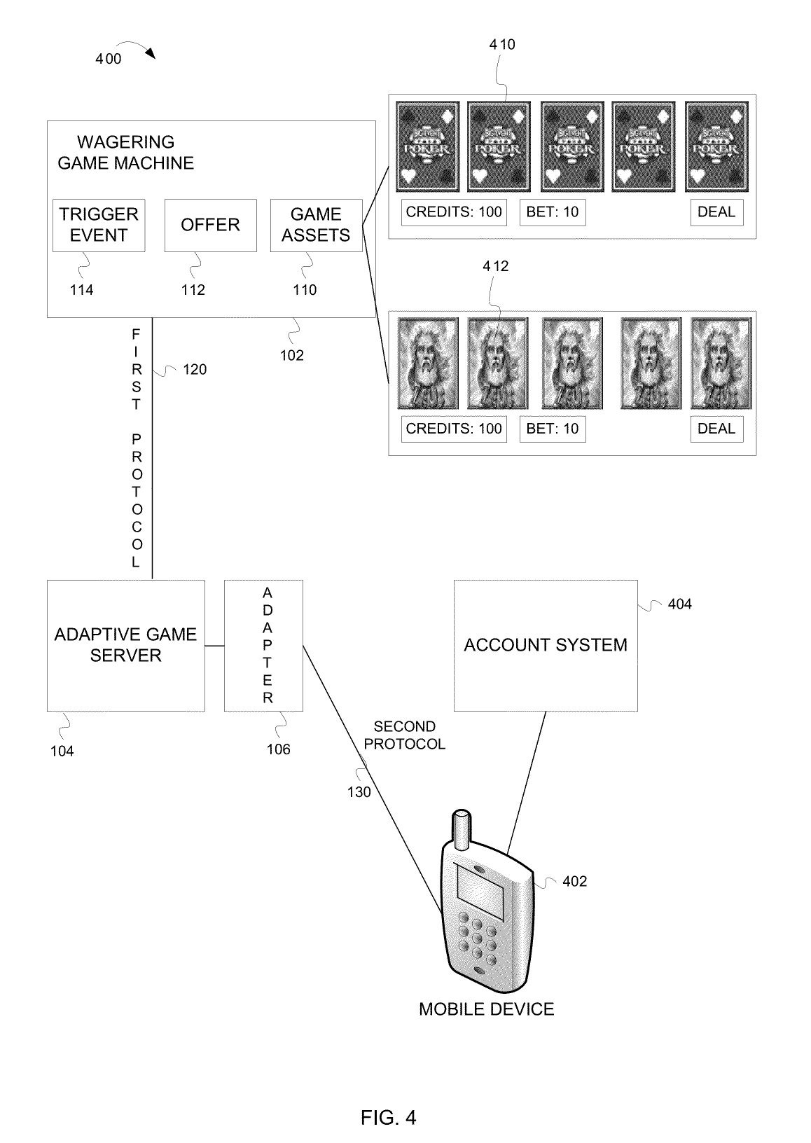

FIG. 4 illustrates a wagering game system 400 in which an adapter communicates with a mobile device to support adaptive gaming functions. In some embodiments, wagering game system 400 includes wagering game machine 102, adaptive game server 104, adapter 106, mobile device 402, and account system 404. Wagering game machine 102, adaptive game server 104 and adapter 106 have been described above. Mobile device 402 may be a mobile phone, tablet computer, personal digital assistant, or other personal device that can communicate data with adapter 106. Account system 404 may be any type of system that maintains accounts for users. In some embodiments, the account system 404 maintains accounts that are bank accounts or credit accounts that use monetary value (e.g., dollars) as currency. In alternative embodiments, account system 402 is a loyalty system that uses loyalty points or reward points as currency. Other account systems may be used and are in the scope of the inventive subject matter.

The operation of wagering game system 400 will be described with reference to an example card based wagering game operating on wagering game machine 102. The card deck used the wagering game may have a default card back illustrated as card back 410. During the operation of wagering game system 400, a user logs in at wagering game machine 102, for example by inserting a player tracking card or by entering a user name and password. Wagering game machine 102 communicates the login event and user identification to adaptive game server 104. Adaptive game server 104 determines that the user has a mobile device 402. For example, adaptive game server 104 may consult a player tracking database having information associated with the user identification that indicates that the user has a mobile device and addressing information associated with the mobile device. Adaptive game server 104 then sends a message containing an offer associated with game assets 110 to the user's mobile device 402. The offer may be an offer to unlock particular gaming assets, for example customized card backs 412, in exchange for a certain number of loyalty points or amount of money maintained in a user's account. In order to send the message, adaptive game server 104 uses adapter 106 to adapt the message prior to sending the message to mobile device 402. For example, adapter 106 may adapt the message to the particular type of mobile device 402, or to a communications protocol used by mobile device 402 or an application executing on mobile device 402.

In some embodiments, an application executing on the user's mobile device receives the message and displays the offer to the user. The application may use various alerting mechanisms available on the mobile device to alert the user to the fact that an offer is being displayed. A user interface for the application provides display interface elements that are used to indicate whether the user accepts or declines the offer. If the user accepts the offer, the application communicates with account system 404 and the currency or loyalty points indicated in the offer are deducted from the user's account on account system 404. In the example shown, default card backs 410 are replaced with custom card backs 412.

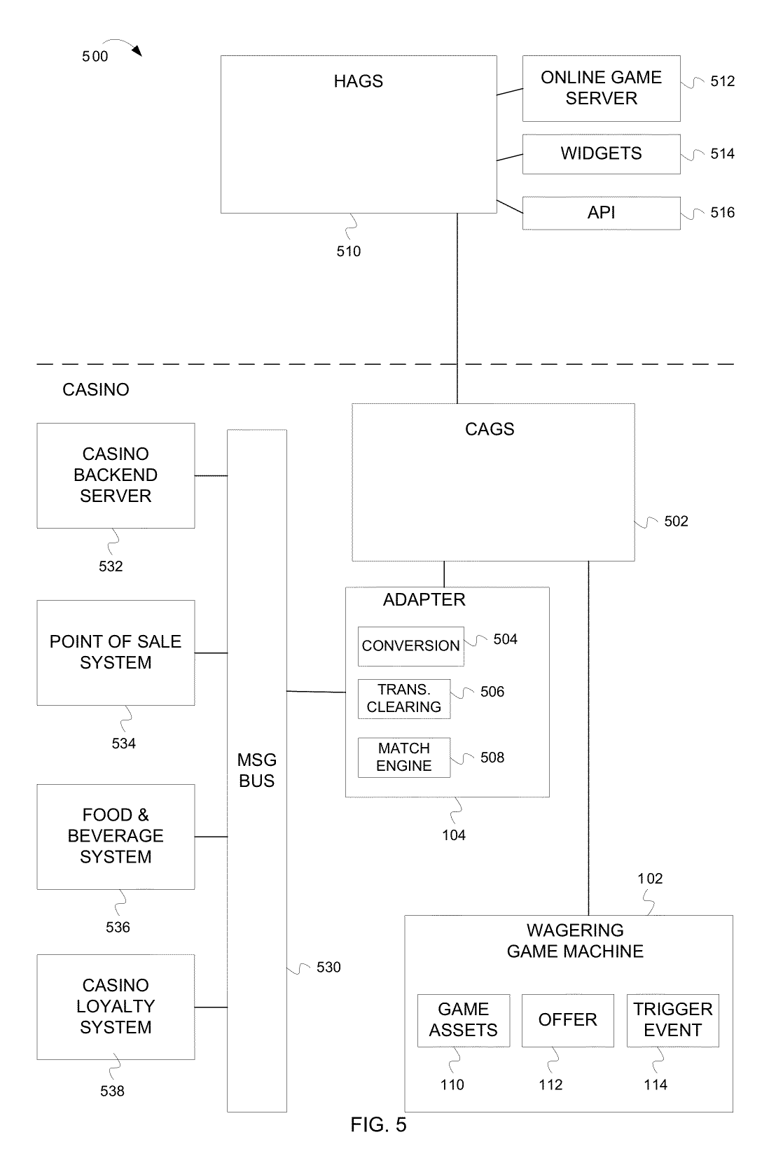

FIG. 5 depicts components of a wagering game system 500 in which the adaptive gaming server 104 is distributed across a casino adaptive gaming server 502 and a host adaptive gaming server 510. Generally speaking, host adaptive gaming server 510 is typically located outside of a casino environment while casino adaptive gaming server 502 is typically located within a casino environment. A host adaptive gaming server 510 may be communicably coupled to multiple casino adaptive gaming servers. Host adaptive gaming server 510 maintains a database or other data store that stores game preferences, game achievements, or game states associated with a player account. The game preferences, game achievements, or game states may be communicated by host adaptive game server 510 to casino adaptive game server 502 upon detection of a player logging into a wagering game machine 102 in a casino. Casino adaptive game server 502 may then use the preference, achievement, or state information to adapt wagering game machine 102 according to the preferences, achievements, or game state.

In some embodiments, host adaptive gaming server 510 interfaces with online game server 512. Online game server 512 serves non-wagering games to client devices outside of a physical casino environment. A client device may be a personal computer, laptop computer, tablet computer or mobile device such as a mobile phone. Online game server 512 may also provide online wagering games in jurisdictions that allow online wagering. In some embodiments, the non-wagering games may operate similarly to wagering games or bonus games available on wagering game located in a casino. Further, the non-wagering games served by an online game server may provide opportunities for earning game achievements or loyalty points that may be used to unlock bonus games or game features of wagering games provided in a casino.

Further, host adaptive gaming server 510 may provide widgets 514 and an API 516. Widgets 514 are typically small, limited purpose programs that enable a user to perform a function or access a service provided by host adaptive gaming server 510.

API 516 provides a programming interface that allows programs such as third party service providers to interface with host adaptive gaming server 510.

Casino adaptive gaming server 502 operates cooperatively with host adaptive gaming server 510 to provide adaptive gaming services in a particular casino. Casino adaptive gaming server 502 is communicably coupled to wagering game machines in a casino and uses information obtained from host adaptive gaming server 510 to provide adaptive wagering games on a wagering game machine 102. For example, upon notification of a login on a wagering game machine 102 (e.g., through insertion of a player tracking card or entering a user identification and password), casino adaptive gaming server 502 communicates with host adaptive gaming server 510 to obtain player preferences, game achievements, or game state information from host adaptive gaming server 510, and uses the information to adapt the operation of a wagering game presented by wagering game machine 102 according to the preferences, game achievements or game state.

A casino may utilize other systems and servers as part of its operations. As an example, a casino may include one or more of a casino backend server 532, a point of sale system 534, a food and beverage system 536, and a casino loyalty system 538. Casino backend server 532 provides various services such as accounting services, analytics services, reporting services and management services for a casino.

Point of sale system 534 generally includes point of sale terminals and servers that manage purchase transactions at a casino. Such transactions may include purchases made at stores, spas, resort facilities and the like that are operated by the casino.

Food and beverage system 536 includes systems that manage orders and purchases of food and beverages in a casino.

In some embodiments, casino backend server 532, point of sale system 534, food and beverage system 536, and casino loyalty system 538 may send and receive messages from one another and from other systems via a message bus 530. Message bus 530 provides a software infrastructure for communicating messages between entities interfaced with message bus 530. In general, messages on the message bus 530 conform to a previously agreed upon schema and a set of common command messages. Messages may be sent asynchronously, that is, there is no requirement for a request/response paradigm for communication. In some embodiments, message bus 530 is a TIBCO message bus available from TIBCO Software Inc.

Casino loyalty system 538 is a system that awards loyalty points to players in exchange for players' activities in a casino. Loyalty points may be awarded based on amounts wagered at a casino, purchases made at casino properties, rooms booked at casino properties, services purchased at casino properties, and other activities that a casino may choose to award loyalty points. Loyalty points are typically associated with a player account. The account may be identified using a player tracking card issued to the player by a casino.

As discussed above, adapter 106 operates as a gateway between third party systems designed to communicate data on message bus 530 such as casino backend server 532, point of sale system 534, food and beverage system 536, and casino loyalty system 538 and systems provided by a wagering game machine vendor such as adaptive gaming servers 502 and 510 and wagering game machine 102. In varying embodiments, adapter 106 includes one or more of a conversion unit 504, a transaction clearing unit 506 or a match engine 508.

Conversion unit 504 converts data, messages and commands of a first communications protocol to data, messages and commands for a second communications protocol. In the example illustrated in FIG. 5, conversion unit 504 converts data, messages and commands from casino adaptive gaming server 502 to a format that is compatible with message bus 530. Various types of conversion may be performed such as splitting data into multiple messages, combining multiple data structures into single messages, rearranging data, mapping identifiers from one system to another etc.

Transaction clearing unit 506, when present, operates as a clearing house for monetary and loyalty point transactions where one side of the transaction is on the message bus and the other side of the transaction is on an adaptive game server or system communicably coupled to an adaptive game server. As an example, various forms of activities on a wagering game machine 102 may involve addition or deduction of loyalty points from a casino loyalty system 538. Alternatively, purchases tracked by point of sale system 534 or food and beverage system 536 may result in triggering offers to a player on a wagering game machine. Transaction clearing unit routes the transaction to the appropriate system based on the transaction and transaction parties.

Match engine 508, when present, provides a message matching capability to adapter 106. Match engine 508 examines messages as they appear on the message bus and applies matching rules to determine if the message may be of interest to a system on the other side of the adapter from the message bus such as casino adaptive gaming server 502 or host adaptive gaming server 506. Matching may be based on business rules that look at one or more fields of a message to determine if the message matches the criteria specified by the business rule. Additionally, fuzzy matching techniques may be performed to determine messages that match a business rule.

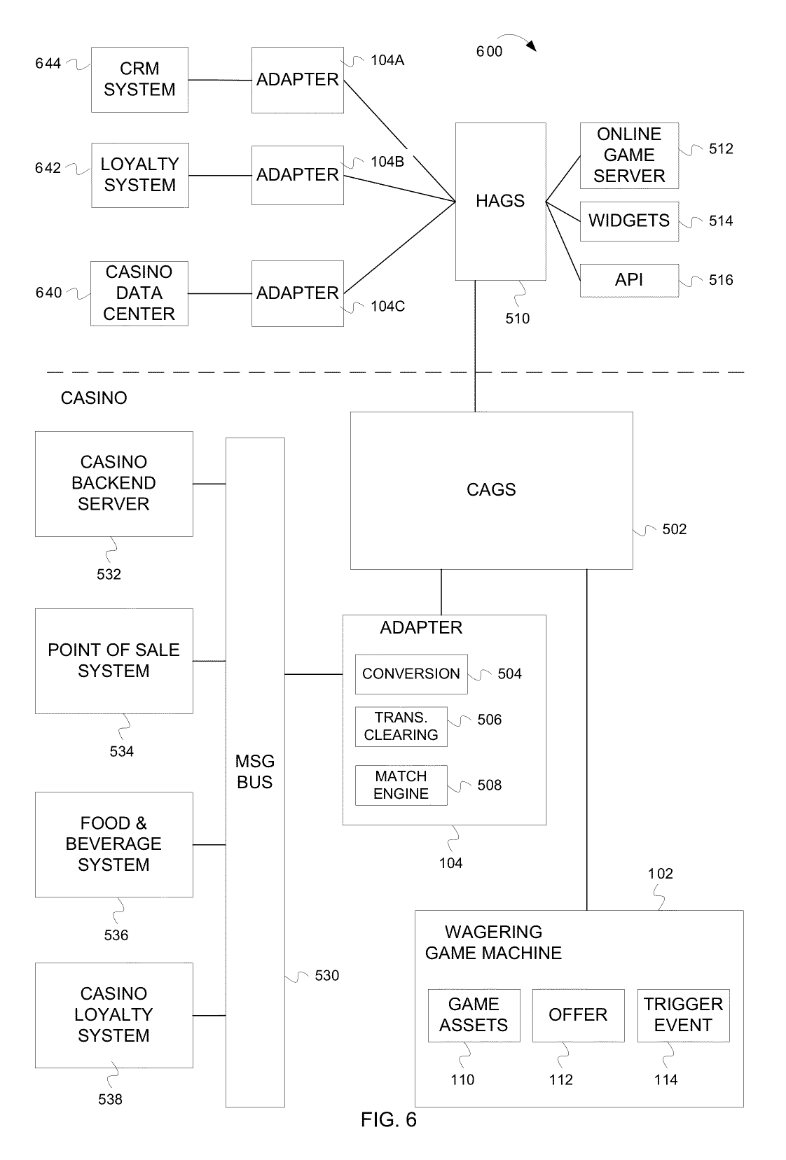

FIG. 6 depicts components of a wagering game system 600 in which a host adaptive gaming server 510 uses an adapter 104 to communicate with third party systems. Wagering game system 600 includes many of the same components as system 500 discussed above. In the example embodiments represented in FIG. 6, host adaptive gaming server 510 uses adapters 104A-104C to communicate with one or more of third party systems CRM (Customer Relationship Manager) 644, loyalty system 642 or casino data center 640.

CRM 644 maintains data regarding a casino's relationships and interactions with its customers (e.g., players). Such data may include demographic information about a player, purchases made by a player, amount of money spent in a casino operator's casinos by a player, customer service interactions with the player and information useful to the casino in marketing goods or services to a player. In addition, CRM system may maintain data regarding advertising campaigns being conducted by a casino operator, including target demographics for the ad campaign, timing and duration of the ad campaign, and results of the ad campaign.

Loyalty system 642 may be any type of loyalty system in which a participant is awarded points in exchange for purchases or activity with a vendor of goods or services. Examples of such loyalty systems include frequent flyer programs, frequent car rental programs, frequent stayer programs, and credit card rewards programs.

Casino data center 640 may include various systems used by a casino operator to manage one or more of its casino properties. For example, any of casino backend server 532, point of sale system 534, food and beverage system 536 or casino loyalty system may be part of casino data center 640. Providing such systems in a data center is useful when a casino operator manages multiple properties and provides similar services at each of the properties.

Adapter 104A -104C couple host adaptive gaming server 510 to CRM system 644, loyalty system 642 and casino data center 640 respectively. Each of adapters 104A-104C can provide the conversion, transaction clearing and match engine services described above to the third party system it is communicably coupled with.

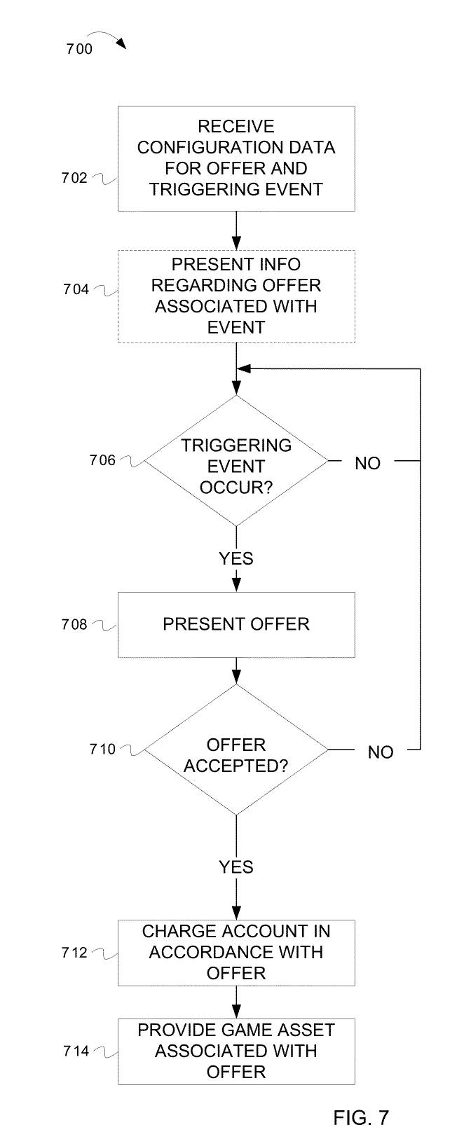

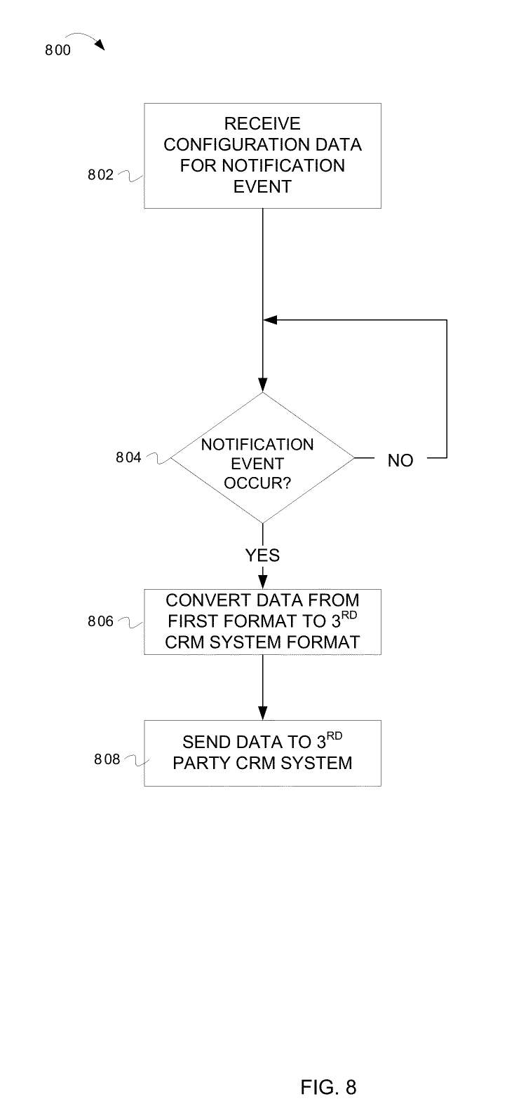

Further details on the operation of the systems described in FIGS. 1-6 are provided below with reference to FIGS. 7 and 8.

### Example Operations

This section describes operations associated with some embodiments of the invention. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

The section will discuss FIGS. 7-8. The discussion of FIG. 7 will describe operations for providing offers to wagering game players in response to real time events occurring on a wagering game machine. The discussion of FIG. 8 will describe operations for real time monitoring of events on a wagering game machine and notifying a third party system of when desired events occur.

FIG. 7 is a flowchart depicting a method 700 for providing offers to wagering game players in response to real time events occurring on a wagering game machine. The method begins at block 702 with receiving configuration data for an offer, and a trigger event or events associated with the offer. In some embodiments, the configuration data may be received and stored on a wagering game machine 102. In alternative embodiments, the configuration data may be received and stored on an adaptive game server. Many types of offers can be configured, and multiple offers and/or trigger events may be included with the configuration data. In some embodiments, the offer may be an offer to unlock wagering game or bonus game content in exchange for loyalty points or cash amounts. Examples of such offers include:
Permanently unlocking a wagering game or bonus game that would otherwise be unavailable to the player.
Temporarily unlocking a wagering game or bonus game to provide a sneak preview of the wagering game or bonus game. The wagering game or bonus game may be unlocked for a particular duration of time or number of plays. The duration of time or number of plays may vary depending on the loyalty points or cash amount required to temporarily unlock the wagering game or bonus game.

In further embodiments, the offer may comprise an offer to customize a wagering game or bonus game in exchange for loyalty points or cash amounts. Examples of such offers include:
Providing additional paylines on a slots based wagering game.
Providing additional wild symbols.
Adding characters, avatars, accessories or other objects to the wagering game or bonus game.
Customizing the appearance of symbols, characters, avatars or other objects appearing in a wagering game or bonus game.

In still further embodiments, the offer may comprise an offer to allow the player to reserve a wagering game or wagering game machine. The offer may be to reserve the wagering game or wagering game machine at some point in time in the future. The amount of loyalty points or cash to make the reservation may vary depending on the reservation time. For example, reserving a wagering game at a time that is projected to be a busy time for the casino may cost more loyalty points or cash than a reservation at a time when the casino is projected to be less busy. Alternatively, the offer may be to reserve or hold the wagering game machine from the current point in time and for a particular duration of time. In either the future reservation or the current reservation, the duration of the reservation may affect the amount of loyalty points or cash required for the reservation.

Those of skill in the art having the benefit of the disclosure will appreciate that other offers are possible and within the scope of the inventive subject matter.

Various trigger events may be include in the configuration data. In some embodiments, a trigger event may comprise reaching a configured achievement level. As an example, a player may be offered the opportunity to advance to the next level of a set of bonus games in exchange for loyalty points or cash. This allows the player to advance sooner by skipping a level. In some embodiments, a trigger event comprises a configured coin-in amount or coin-in rate.

In some embodiments, at block 704 the information regarding the offer is displayed to the player at the wagering game machine. The player can thus be informed that an offer will be made if the player meets the conditions of the offer (e.g., the trigger event for the offer). In alternative embodiments, information about the offer is not displayed until after the trigger event.

At block 706, the system determines if the trigger event has occurred. If the event has not occurred, the system returns to block 706 to wait for the occurrence of the trigger event.

Alternatively, if the trigger event has occurred, then at block 708 the wagering game machine displays the offer associated with the trigger event, and provides an interface for the player to accept or decline the offer.

At block 710, the wagering game machine determines if the offer has been accepted or declined. If the offer is declined, the wagering game machine returns to block 706 to await the occurrence of further triggering events.

Alternatively, if the offer is accepted, then at block 712 the player's account is charged according to the offer. In some embodiments, a message is sent to the loyalty system to deduct loyalty points in accordance with the offer. If the loyalty system is maintained by a third party (casino loyalty system, hotel loyalty system, airline loyalty system etc.), an adapter may be used to convert the transaction message into a format compatible for communication to the third party system.

At block 714, the wagering game provides the game asset (e.g., unlocked game, game feature etc.) associated with the offer. Providing the game asset is dependent on receiving a notification from the loyalty system that the loyalty points were successfully deducted from the player loyalty account. In some embodiments, an adaptive game server downloads the game asset to the wagering game machine. In alternative embodiments, the game asset may already be stored on the wagering game machine and is made available to the player.

FIG. 8 is a flowchart illustrating a method 800 for real time monitoring of events on a wagering game machine and notifying a third party system of when desired events occur. The method begins at block 802 with receiving configuration data for one or more notification events. In some embodiments, the notification events comprise events that occur on a wagering game machine that are to be communicated to a third party system such as a CRM system 644 (FIG. 6). As with trigger events, notification events may comprise various types of events such as reaching a configured achievement level, or reaching a configured coin-in amount or coin-in rate.

In some embodiments, the configuration data for the notification event may be entered by a casino operator through an interface provided by an adaptive gaming server. For example, an adaptive gaming server may provide a user interface that lists notification events available on the system. A casino operator may use the interface to select events of interest to the casino operator. Additionally, notification events may be “prepackaged” by a wagering game machine provider. That is, certain combinations of events that are expected to be of interest to the casino operator may be preconfigured and available for selection.

The configuration data may be maintained on an adaptive gaming server, or it may be downloaded and maintained on a wagering game machine.

At block 804, the system determines if the notification event has occurred. If the notification event has not occurred, the system returns to the beginning of block 804 to await the occurrence of a notification event.

Otherwise, if the notification event has occurred, then at block 806 the system obtains data regarding the notification event and converts the data into a format that is compatible with a communications protocol for a CRM system. The data may include an identifier for the event, a player id that was playing the wagering game at the time of the event, and other operational data from the wagering game machine at the time of the event.

At block 808, the system sends the converted data to the CRM system. In some embodiments, an adapter is used to perform the conversion of the data into the appropriate format for the CRM system and to transmit the data to the CRM system.

After receiving the data, the CRM system may use the data to compose an offer to the player. The offer may be transmitted back from the CRM system to an adaptive game server for presentation on a wagering game machine communicably coupled to the adaptive game server. Alternatively, the offer may be emailed or postal mailed to the player using information available from the CRM system.

### Operating Environment

This section describes an example operating environment and presents structural aspects of some embodiments. This section includes discussion about wagering game machine architectures and wagering game networks.

### Wagering Game Machine Architectures

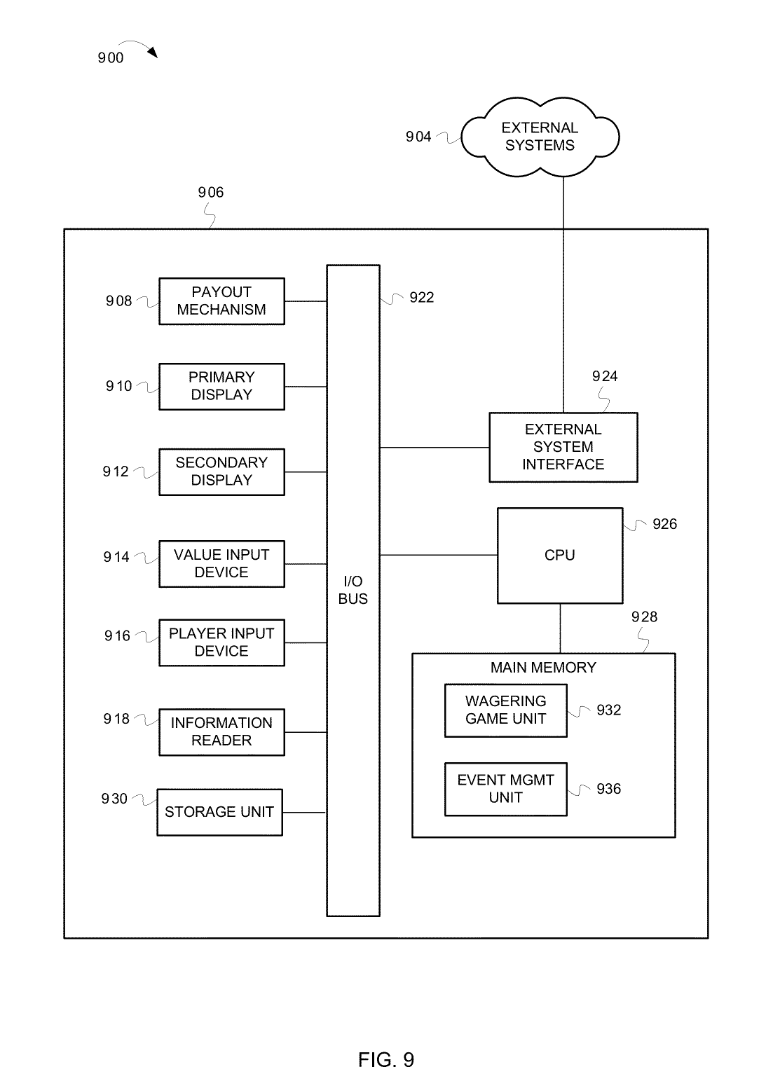

FIG. 9 is a block diagram illustrating a wagering game machine architecture, according to example embodiments of the invention. As shown in FIG. 9, the wagering game machine architecture 900 includes a wagering game machine 906, which includes a central processing unit (CPU) 926 connected to main memory 928. The CPU 926 can include any suitable processor, such as an Intel® Pentium processor, Intel® Core 2 Duo processor, AMD Opteron™ processor, or U1traSPARC processor. The main memory 928 includes a wagering game unit 932. In one embodiment, the wagering game unit 932 can present wagering games, such as video poker, video black jack, video slots, video lottery, etc., in whole or part.

The CPU 926 is also connected to an input/output (I/O) bus 922, which can include any suitable bus technologies, such as an AGTL+ frontside bus and a PCI backside bus. The I/O bus 922 is connected to a payout mechanism 908, primary display 910, secondary display 912, value input device 914, player input device 916, information reader 918, and storage unit 930. The player input device 916 can include the value input device 914 to the extent the player input device 916 is used to place wagers. The I/O bus 922 is also connected to an external system interface 924, which is connected to external systems 904 (e.g., wagering game networks).

In one embodiment, the wagering game machine 906 can include additional peripheral devices and/or more than one of each component shown in FIG. 9. For example, in one embodiment, the wagering game machine 906 can include multiple external system interfaces 924 and/or multiple CPUs 926. In one embodiment, any of the components can be integrated or subdivided.

Any component of the architecture 900 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

While FIG. 9 describes an example wagering game machine architecture, this section continues with a discussion wagering game networks.

### Wagering Game Networks

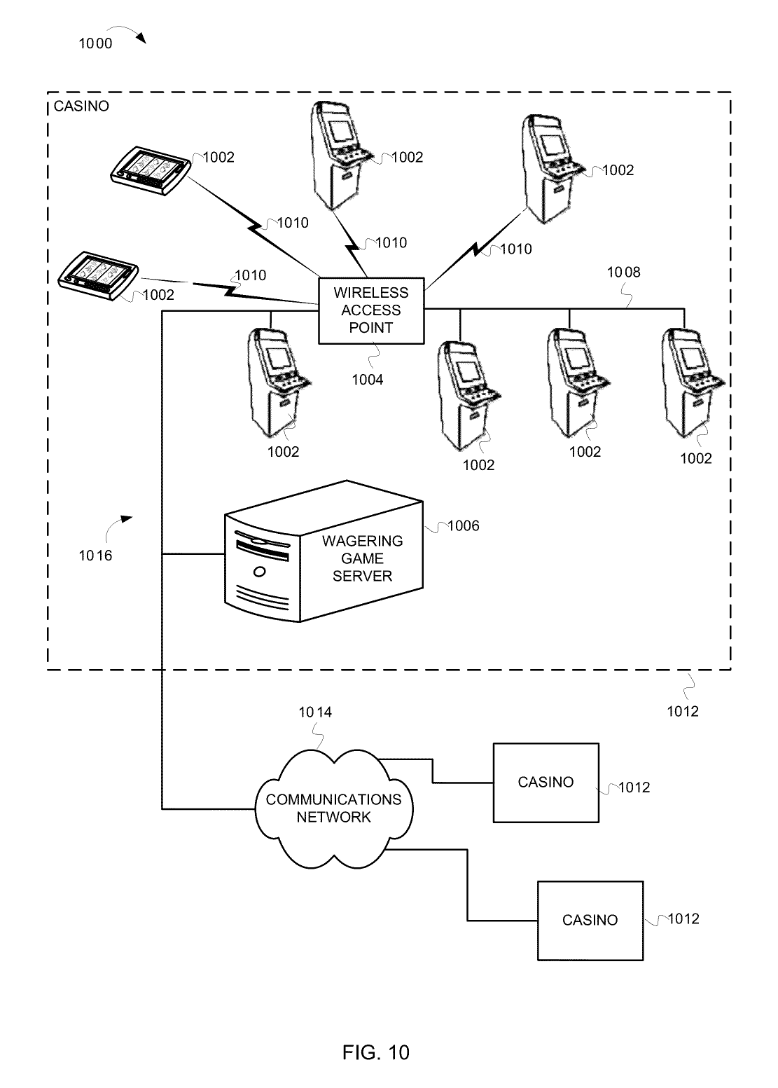

FIG. 10 is a block diagram illustrating a wagering game network 1000, according to example embodiments of the invention. As shown in FIG. 10, the wagering game network 1000 includes a plurality of casinos 1012 connected to a communications network 1014.

Each casino 1012 includes a local area network 1016, which includes an access point 1004, a wagering game server 1006, and wagering game machines 1002. The access point 10304 provides wireless communication links 1010 and wired communication links 1008. The wired and wireless communication links can employ any suitable connection technology, such as Bluetooth, 802.11, Ethernet, public switched telephone networks, SONET, etc. In some embodiments, the wagering game server 1006 can serve wagering games and distribute content to devices located in other casinos 1012 or at other locations on the communications network 1014.

The wagering game machines 1002 described herein can take any suitable form, such as floor standing models, handheld mobile units, bartop models, workstation-type console models, etc. Further, the wagering game machines 1002 can be primarily dedicated for use in conducting wagering games, or can include non-dedicated devices, such as mobile phones, personal digital assistants, personal computers, etc. In one embodiment, the wagering game network 1000 can include other network devices, such as accounting servers, wide area progressive servers, player tracking servers, and/or other devices suitable for use in connection with embodiments of the invention.

In some embodiments, wagering game machines 1002 and wagering game servers 1006 work together such that a wagering game machine 1002 can be operated as a thin, thick, or intermediate client. For example, one or more elements of game play may be controlled by the wagering game machine 1002 (client) or the wagering game server 1006 (server). Game play elements can include executable game code, lookup tables, configuration files, game outcome, audio or visual representations of the game, game assets or the like. In a thin-client example, the wagering game server 1006 can perform functions such as determining game outcome or managing assets, while the wagering game machine 1002 can present a graphical representation of such outcome or asset modification to the user (e.g., player). In a thick-client example, the wagering game machines 1002 can determine game outcomes and communicate the outcomes to the wagering game server 1006 for recording or managing a player's account.

In some embodiments, either the wagering game machines 1002 (client) or the wagering game server 1006 can provide functionality that is not directly related to game play. For example, account transactions and account rules may be managed centrally (e.g., by the wagering game server 1006) or locally (e.g., by the wagering game machine 1002). Other functionality not directly related to game play may include power management, presentation of advertising, software or firmware updates, system quality or security checks, etc.

Any of the wagering game network components (e.g., the wagering game machines 1002) can include hardware and machine-readable media including instructions for performing the operations described herein.

### Example Wagering Game Machines

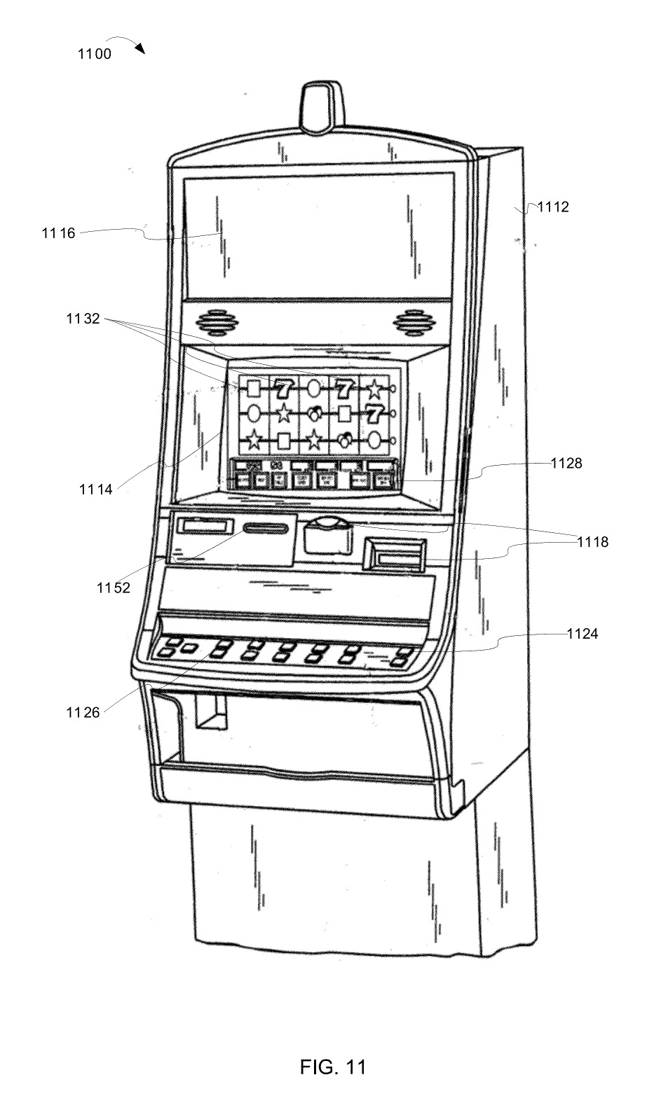

FIG. 11 is a perspective view of a wagering game machine, according to example embodiments of the invention. Referring to FIG. 11, a wagering game machine 1100 is used in gaming establishments, such as casinos. According to embodiments, the wagering game machine 1100 can be any type of wagering game machine and can have varying structures and methods of operation. For example, the wagering game machine 1100 can be an electromechanical wagering game machine configured to play mechanical slots, or it can be an electronic wagering game machine configured to play video casino games, such as blackjack, slots, keno, poker, blackjack, roulette, etc.

The wagering game machine 1100 comprises a housing 1112 and includes input devices, including value input devices 1118 and a player input device 1124. For output, the wagering game machine 1100 includes a primary display 1114 for displaying information about a basic wagering game. The primary display 1114 can also display information about a bonus wagering game and a progressive wagering game. The wagering game machine 1100 also includes a secondary display 1116 for displaying wagering game events, wagering game outcomes, and/or signage information. While some components of the wagering game machine 1100 are described herein, numerous other elements can exist and can be used in any number or combination to create varying forms of the wagering game machine 1100.

The value input devices 1118 can take any suitable form and can be located on the front of the housing 1112. The value input devices 1118 can receive currency and/or credits inserted by a player. The value input devices 1118 can include coin acceptors for receiving coin currency and bill acceptors for receiving paper currency. Furthermore, the value input devices 1118 can include ticket readers or barcode scanners for reading information stored on vouchers, cards, or other tangible portable storage devices. The vouchers or cards can authorize access to central accounts, which can transfer money to the wagering game machine 1100.

The player input device 1124 comprises a plurality of push buttons on a button panel 1126 for operating the wagering game machine 1100. In addition, or alternatively, the player input device 1124 can comprise a touch screen 1128 mounted over the primary display 1114 and/or secondary display 1116.

The various components of the wagering game machine 1100 can be connected directly to, or contained within, the housing 1112. Alternatively, some of the wagering game machine's components can be located outside of the housing 1112, while being communicatively coupled with the wagering game machine 1100 using any suitable wired or wireless communication technology.

The operation of the basic wagering game can be displayed to the player on the primary display 1114. The primary display 1114 can also display a bonus game associated with the basic wagering game. The primary display 1114 can include a cathode ray tube (CRT), a high resolution liquid crystal display (LCD), a plasma display, light emitting diodes (LEDs), or any other type of display suitable for use in the wagering game machine 1100. Alternatively, the primary display 1114 can include a number of mechanical reels to display the outcome. In FIG. 11, the wagering game machine 1100 is an “upright” version in which the primary display 1114 is oriented vertically relative to the player. Alternatively, the wagering game machine can be a “slant-top” version in which the primary display 1114 is slanted at about a thirty-degree angle toward the player of the wagering game machine 1100. In yet another embodiment, the wagering game machine 1100 can exhibit any suitable form factor, such as a free standing model, bartop model, mobile handheld model, or workstation console model.

A player begins playing a basic wagering game by making a wager via the value input device 1118. The player can initiate play by using the player input device's buttons or touch screen 1128. The basic game can include arranging a plurality of symbols along a payline 1132, which indicates one or more outcomes of the basic game. Such outcomes can be randomly selected in response to player input. At least one of the outcomes, which can include any variation or combination of symbols, can trigger a bonus game.

In some embodiments, the wagering game machine 1100 can also include an information reader 1152, which can include a card reader, ticket reader, bar code scanner, RFID transceiver, or computer readable storage medium interface. In some embodiments, the information reader 1152 can be used to award complimentary services, restore game assets, track player habits, etc.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
receiving configuration data for a trigger event and an offer associated with one or more game assets;
in response to detecting the occurrence of the trigger event, presenting the offer associated with one or more game assets; and
in response to acceptance of the offer, performing operations comprising:
providing at least one of the one or more game assets, and charging a player account in accordance with the offer.

2. The method of claim 1, wherein charging the player account in accordance with the offer includes performing operations comprising:
converting data for charging the player account from a first format to a second format compatible with a third party loyalty system; and
transmitting the converted data to the third party loyalty point system.

3. The method of claim 1, wherein receiving configuration data includes receiving the configuration data on a wagering game machine;

4. The method of claim 1, wherein receiving configuration data includes receiving the configuration data on an adaptive gaming server.

5. The method of claim 1, wherein the offer comprises an offer to unlock at least one of the one or more game assets.

6. The method of claim 1, wherein the offer comprises an offer to customize the operation of a wagering game or a bonus game.

7. The method of claim 1, wherein the offer comprises an offer to reserve a wagering game.

8. The method of claim 1, wherein the trigger event comprises one or more of achieving a level in a bonus game or wagering game, a coin-in amount, or a coin-in rate.

9. A method comprising:
receiving configuration data for a notification event;
in response to detecting the occurrence of the notification event on a wagering game machine, performing operations comprising:
converting event data for the notification event from a first format to a second format compatible with a third party customer relationship management system; and
transmitting the converted data to the third party customer relationship management system.

10. The method of claim 9, wherein the notification event comprises one or more of achieving a level in a bonus game or wagering game, a coin-in amount, or a coin-in rate.

11. A system comprising:
a wagering game machine having one or more processors configured to present a wagering game upon which monetary value may be wagered;
a set of game assets for the wagering game machine; and
an adaptive game server communicably coupled to the wagering game machine and configured to manage the set of game assets for the wagering game machine;
wherein the wagering game machine, in response to a trigger event, is configured to present an offer associated with one or more game assets; and
wherein the adaptive game server, in response to acceptance of the offer, is configured to perform operations comprising:
provide at least one of the one or more game assets, and
charge a player account in accordance with the offer.

12. The system of claim 11, and further comprising an adapter configured to perform operations comprising:
convert data for charging the player account from a first format to a second format compatible with a third party loyalty system; and
transmit the converted data to the third party loyalty point system.

13. The system of claim 11, wherein the set of game assets are maintained on the wagering game machine.

14. One or more computer-readable media having stored thereon computer executable instructions for causing one or more processors to perform operations comprising:
receiving configuration data for a trigger event and an offer associated with one or more game assets;
in response to detecting the occurrence of the trigger event, presenting the offer associated with one or more game assets; and
in response to acceptance of the offer, performing operations comprising:
providing at least one of the one or more game assets, and
charging a player account in accordance with the offer.

15. The one or more computer-readable media of claim 14, wherein charging the player account in accordance with the offer includes performing operations comprising:
converting data for charging the player account from a first format to a second format compatible with a third party loyalty system; and
transmitting the converted data to the third party loyalty point system.

16. The one or more computer-readable media of claim 14, wherein receiving configuration data includes receiving the configuration data on a wagering game machine;

17. The one or more computer-readable media of claim 14, wherein receiving configuration data includes receiving the configuration data on an adaptive gaming server.

18. The one or more computer-readable media of claim 14, wherein the offer comprises an offer to unlock at least one of the one or more game assets.

19. The one or more computer-readable media of claim 14, wherein the offer comprises an offer to customize the operation of a wagering game or a bonus game.

20. The one or more computer-readable media of claim 14, wherein the offer comprises an offer to reserve a wagering game.

21. The one or more computer-readable media of claim 14 wherein the trigger event comprises one or more of achieving a level in a bonus game or wagering game, a coin-in amount, or a coin-in rate.

22. A system comprising:
means for receiving configuration data for a trigger event and an offer associated with one or more game assets;
means for detecting the occurrence of the trigger event, and in response to detecting the occurrence of the trigger event, presenting the offer associated with one or more game assets; and
means for receiving an acceptance of the offer, and in response to acceptance of the offer, performing operations comprising:
providing at least one of the one or more game assets, and charging a player account in accordance with the offer.

23. The system of claim 22, wherein charging the player account in accordance with the offer includes performing operations comprising:
converting data for charging the player account from a first format to a second format compatible with a third party loyalty system; and
transmitting the converted data to the third party loyalty point system.

24. The system of claim 22, wherein receiving configuration data includes receiving the configuration data on a wagering game machine;

25. The system of claim 22, wherein the offer comprises an offer to unlock at least one of the one or more game assets.
